(19) United States
(12) Patent Application Publication
(10) Pub. No.: US 2016/0208517 A1
(43) Pub. Date: Jul. 21, 2016

(54) VEHICLE TAILGATE LOCKING ELEMENT GUARD

(71) Applicant: FORD GLOBAL TECHNOLOGIES, LLC, Dearborn, MI (US)

(72) Inventor: Robin Oliver DARGEL, Cologne (DE)

(21) Appl. No.: 14/997,137

(22) Filed: Jan. 15, 2016

(30) Foreign Application Priority Data
Jan. 21, 2015 (DE) 10 2015 200 938.6

(51) Int. Cl. E05B 17/20; E05C 19/02; E05B 83/18; E05B 83/26; B60J 5/10; E05C 3/14

(52) U.S. Cl. CPC E05B 17/20; B60J 5/10; E05C 3/14; E05B 83/18; E05B 83/26; E05C 19/02

(57) ABSTRACT

The invention relates to a guard for locking elements that extend inwardly, or protrude, from an inner surface of a tailgate of a passenger motor vehicle. The guard is disposed in the region of the locking elements. The guard may be made of an elastic material. The guard may fold in and fold out relative to the inner surface of the tailgate. The guard may be configured in the shape of a gripping handle.

### CROSS-REFERENCE TO RELATED APPLICATIONS

This application claims foreign priority benefits under 35 U.S.C. §119(a)-(d) to DE 10 2015 200 938.6 filed Jan. 21, 2015, which is hereby incorporated by reference in its entirety.

### TECHNICAL FIELD

The invention relates to protruding parts of the locking elements a tailgate of a passenger motor vehicle.

### BACKGROUND

In motor vehicles, in particular passenger motor vehicles, it is known to be a problem to prevent people being trapped when closing the doors or panels. It is equally difficult to prevent people from coming into contact with protruding parts of the locking elements of the doors or panels.

A method and a device for controlling an adjusting movement of a vehicle closing element of a vehicle, to be closed in a manner actuated by an external force, is disclosed in DE 10 2012 107 116 A1. A bodywork opening of the vehicle is able to be closed by the vehicle closing element. The vehicle closing element comprises a locking part by which the vehicle closing element is able to be locked in the closed position. A capacitive anti-trap system senses an obstruction in the displacement path of the vehicle closing element is able to be detected while closing. The anti-trap system controls displacement of the vehicle closing element to prevent an obstruction from being trapped between the vehicle closing element and a vehicle structure in the region of the bodywork opening. The capacitive anti-trap system detects an obstruction in a monitoring region around the locking part provided on the vehicle closing element to prevent a collision of the locking part with an obstruction as the vehicle closing element is closed.

The capacitive anti-trap system is used to prevent people from being trapped and partially to prevent people from being struck. The capacitive anti-trap system method and/or device is complex and costly and is only expedient in the case of automatic self-closing doors or panels.

There is the need for a simple solution for preventing people from striking protruding parts of the locking elements of tailgates of motor vehicles.

### SUMMARY

According to one aspect of this disclosure, a warning or blocking element, herein after referred to as a guard, is arranged in the region of the protruding parts of the locking elements to prevent a person from striking the protruding part. The guard provides a warning that causes to people pay attention to the protruding parts of the locking elements. The guard also prevents undesired contact of the person with the protruding parts of the locking elements by deflecting and/or by damping contact before the person comes into contact with the protruding parts.

The guard is designed to be visually noticeable in terms of size and/or color. A fluorescent color may be used on the guard or it may be arranged in a prominent manner.

The guard may be designed to prevent undesired contact with the protruding parts of the locking elements by covering the protruding parts. The protruding parts of the locking elements may be partially covered when viewed from one direction.

It is also possible to design the guard to be movable between a position covering the protruding parts of the locking elements and a folded-in position in which the guard is “folded away” to prevent interference when closing the tailgate.

Alternatively, the guard may consist of an elastic material that recovers its size and shape after compression. The elastic guard dampens an undesired impact of a person and at the same time permits compression when the tailgate is closed, so that the element does not interfere with closing the tailgate.

Additionally, the guard may be configured as a gripping element, or handle.

The guard may fold out when opening the tailgate or when the tailgate reaches a predetermined opening angle.

Folding out and retracting the guard may be assisted by a suitable drive to move the guard rapidly into the folded out position.

Further features and details of the invention are disclosed with reference to the attached drawings.

### BRIEF DESCRIPTION OF THE DRAWINGS

FIG. 1A is a fragmentary perspective view of a tailgate and rear tailgate opening of a passenger motor vehicle including a first exemplary embodiment of a guard;

FIG. 1B is a rear elevation view of the tailgate and rear tailgate opening of the passenger motor vehicle including the first embodiment of a guard;

FIG. 1C is a perspective view of the tailgate of the passenger motor vehicle including the first embodiment of a guard;

FIG. 2A is a fragmentary perspective view of a tailgate and rear tailgate opening of a passenger motor vehicle including a second exemplary embodiment of a guard;

FIG. 2B is a rear elevation view of the tailgate and rear tailgate opening of the passenger motor vehicle including the second embodiment of a guard;

FIG. 2C is a fragmentary perspective view of the floor and of the tailgate of the passenger motor vehicle including the second embodiment of a guard;

FIG. 3A is a fragmentary perspective view of a tailgate and rear tailgate opening of a passenger motor vehicle including a third exemplary embodiment of a guard;

FIG. 3B is a rear elevation view of the tailgate and rear tailgate opening of the passenger motor vehicle including the third embodiment of a guard;

FIG. 3C is a perspective view of the tailgate of the passenger motor vehicle including the third embodiment of a guard;

FIG. 4A is a fragmentary perspective view of a tailgate and rear tailgate opening of a passenger motor vehicle including a fourth exemplary embodiment of a guard;

FIG. 4B is a rear elevation view of the tailgate and rear tailgate opening of the passenger motor vehicle including the fourth embodiment of a guard; and

FIG. 4C is a perspective view of the tailgate of the passenger motor vehicle including the fourth embodiment of a guard.

### DETAILED DESCRIPTION

The illustrated embodiments are disclosed with reference to the drawings. However, it is to be understood that the disclosed embodiments are intended to be merely examples that may be embodied in various and alternative forms. The Figures are not necessarily to scale and some features may be exaggerated or minimized to show details of particular components. The specific structural and functional details disclosed are not to be interpreted as limiting, but as a representative basis for teaching one skilled in the art how to practice the disclosed concepts. The same parts are denoted by corresponding reference numerals in the Figures.

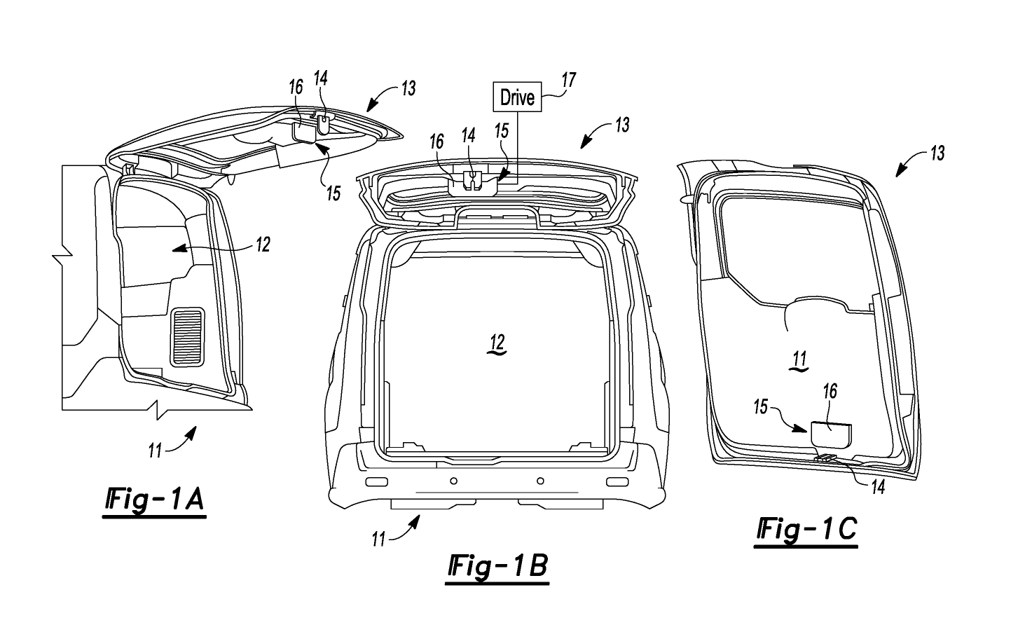

Referring generally to FIGS. 1A-1C, the rear region of a passenger motor vehicle referred to as a whole by 11. The rear region 11 defines a rear vehicle opening 12 and includes a tailgate 13 that is adapted to close the opening. The tailgate 13 is shown in FIGS. 1A and 1B in the open, almost horizontal, position and in FIG. 1C respectively in the closed, almost vertical, position. In each case, the tailgate 13 includes a protruding part 14 of the lock that protrudes approximately perpendicular from the surface of the tailgate 13.

A guard 15 is intended to prevent undesired contact of people, for example, the heads thereof, with the protruding part 14. Undesired contact may be prevented even more effectively by a flap 16 covering the part 14 in the folded-out position. The flap 16 may encompass the protruding part in a jaw-like manner.

In the variant of FIGS. 1A-1C, the guard 15 is configured as a flap 16 that covers the part 14 in the open position of the tailgate 13 as shown in FIG. 1A and 1B on one side and automatically folds in and out in response to the force of gravity. The flap 16 is pulled by gravity into its protective position and when closed may be folded in (and/or pushed away) by the loading floor, etc. of the vehicle 11. The flap 16 may be provided with a drive 17 that assists with folding in and folding out the flap 16.

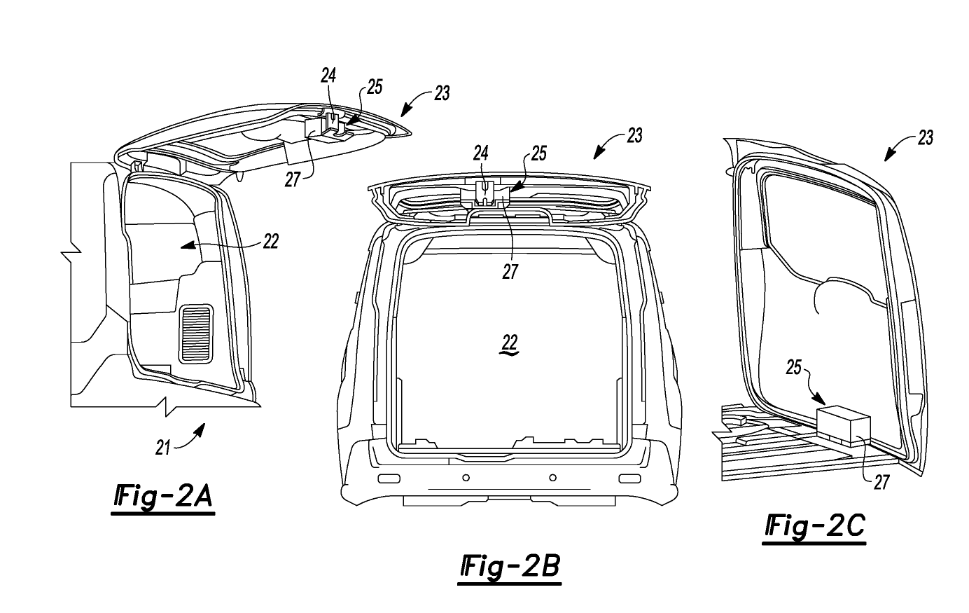

Referring generally to FIGS. 2A-2C, the rear region of a passenger motor vehicle referred to as a whole by 21. The rear region 21 defines a rear vehicle opening 22 and includes a tailgate 23 that is adapted to close the opening. The tailgate 23 is shown in FIGS. 2A and 2B in the open, almost horizontal, position and in FIG. 2C respectively in the closed, almost vertical, position. In each case, the tailgate 23 includes a protruding part 24 of the lock that protrudes approximately perpendicular from the surface of the tailgate 23. A guard 25 is intended to prevent undesired contact of people, for example, the heads thereof, with the protruding part 24.

In the variant Figure of FIG. 2A-2C, the guard 25 is configured as a block 27 that covers the protruding part 24 on one side in FIGS. 2A and 2B an completely covers the protruding part in FIG. 2C. The block 27 may be in the form of a foam block body that is provided for dampening or preventing undesired contact with the protruding part 24.

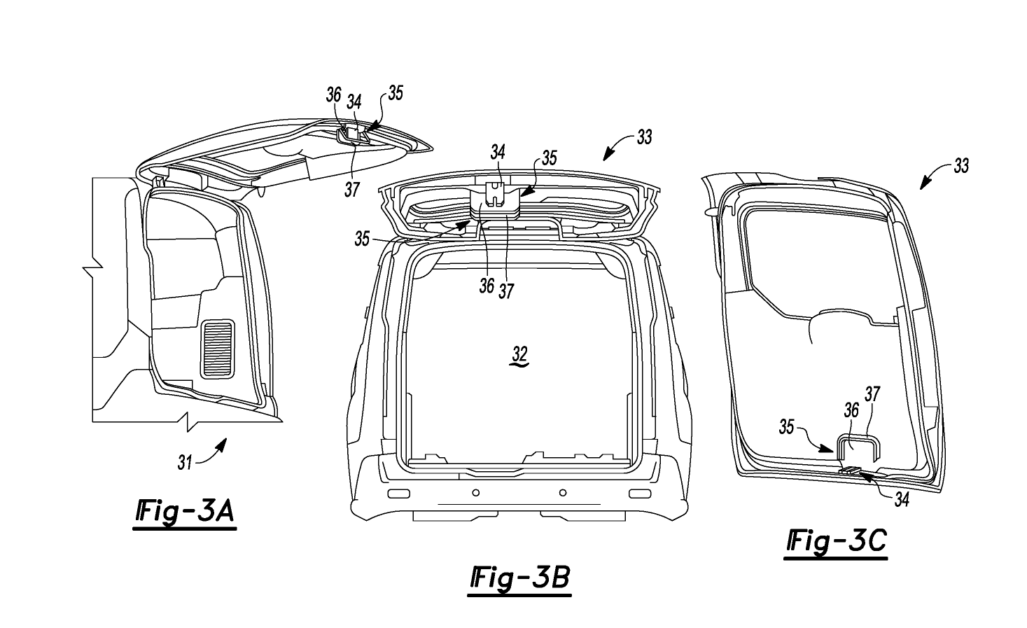

Referring generally to FIGS. 3A-3C, the rear region of a passenger motor vehicle referred to as a whole by 31. The rear region 31 defines a rear vehicle opening 32 and includes a tailgate 33 that is adapted to close the opening. The tailgate 33 is shown in FIGS. 3A and 3B in the open, almost horizontal, position and in FIG. 3C respectively in the closed, almost vertical, position. In each case, the tailgate 33 includes a protruding part 34 of the lock that protrudes approximately perpendicular from the surface of the tailgate 33.

A guard 35 is intended to prevent undesired contact of people, for example, the heads thereof, with the protruding part 34. Undesired contact may be prevented even more effectively by a flap 36 covering the part 34 in the folded-out position.

Referring to FIG. 3A-3C, the guard 35 of FIG. 3 is modified by supplementing the flap 36 with a gripping handle 37 that is folded in and folded out, similar to the embodiment of FIG. 1. The gripping handle 37 in the open position of the tailgate 33 folds out to cover the protruding part 34 in the manner of an antiroll bar. In the closed position of the tailgate 33 (see FIG. 3C) the gripping handle folds together with the flap 36 against the tailgate 33. The gripping handle 37 and flap 36 may be biased, or pre-tensioned, by a spring, a resilient plastic part, or the like.

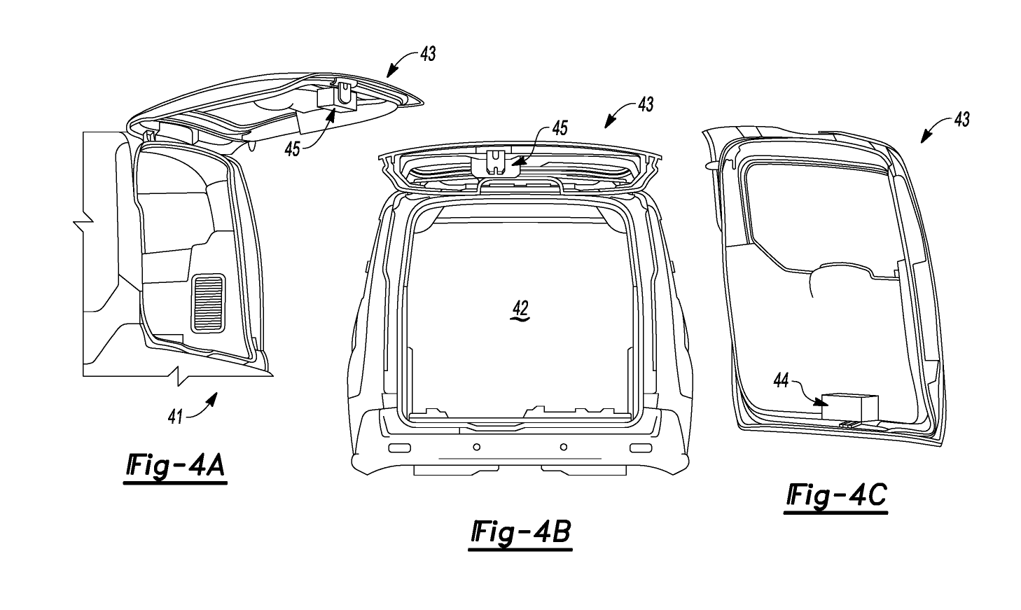

Referring generally to FIGS. 4A-4C, the rear region of a passenger motor vehicle referred to as a whole by 41. The rear region 41 defines a rear vehicle opening 42 and includes a tailgate 43 that is adapted to close the opening. The tailgate 43 is shown in FIGS. 4A and 4B in the open, almost horizontal, position and in FIG. 4C respectively in the closed, almost vertical, position. In each case, the tailgate 43 includes a protruding part 44 of the lock that protrudes approximately perpendicular from the surface of the tailgate 43. A guard 45 is intended to prevent undesired contact of people, for example, the heads thereof, with the protruding part 44.

Referring to FIG. 4A-4C, the guard is configured as an elastic, or reversibly compressible foam block body 45 similar to that already disclosed with reference to FIG. 2.

In summary, the tailgate (13, 23, 33 and 43) assembly for a vehicle (11, 21, 31 and 41) comprises a tailgate (13, 23, 33 and 43) having an inner surface. A locking element (14, 24, 34, and 44) extends inwardly from the inner surface and a guard (15, 25, 35 and 45) is disposed proximate the locking element (14, 24, 34, and 44).

The guard (15, 25, 35 and 45) is large enough to be visible when the tailgate is open and is painted in a color to be visible against the inner surface of the tailgate. For example, the guard (15, 25, 35 and 45) may be painted in a contrasting or fluorescent color that is highly visible against the inner surface of the tailgate.

The guard (15, 25, 35 and 45) may cover the locking element (14, 24, 34, and 44) to prevent contact with the locking element (14, 24, 34, and 44).

The guard (15, 25, 35 and 45) may be movable between a position covering the locking element (14, 24, 34, and 44) and a folded-in position.

The guard (15, 25, 35 and 45) may be formed of an elastic material such as a foam block.

The guard (15, 25, 35 and 45) may be configured as a gripping handle 37.

The guard (15, 25, 35 and 45) may fold out and away from the inner surface of the tailgate (13, 23, 33 and 43) when the tailgate (13, 23, 33 and 43) is raised to a predetermined angle and folds in against the inner surface when the tailgate (13, 23, 33 and 43) is lowered to the predetermined opening angle.

The tailgate (13, 23, 33 and 43) assembly may further comprise a drive operatively connected between the tailgate and the guard that guard folds out the guard away from the inner surface when the tailgate is raised and folds in the guard against the inner surface when the tailgate is lowered.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A tailgate assembly for a vehicle, comprising:
a tailgate having an inner surface;
a locking element extending inwardly from the inner surface; and
a guard proximate the locking element.

2. The tailgate assembly of claim 1, wherein the guard is large enough to be visible when the tailgate is open and is painted in a color to be visible against the inner surface of the tailgate.

3. The tailgate assembly of claim 1, wherein the guard covers the locking element to prevent contact with the locking element.

4. The tailgate assembly of claim 1, wherein the guard is movable between a position covering the locking element and a folded-in position.

5. The tailgate assembly of claim 1, wherein the guard is formed of an elastic material.

6. The tailgate assembly of claim 1, wherein the guard is configured as a gripping handle.

7. The tailgate assembly of claim 1, wherein the guard folds out and away from the inner surface when the tailgate is raised to a predetermined angle and folds in against the inner surface when the tailgate is lowered to the predetermined opening angle.

8. The tailgate assembly of claim 1 further comprising:
a drive operatively connected between the tailgate and the guard that guard folds out the guard away from the inner surface when the tailgate is raised and folds in the guard against the inner surface when the tailgate is lowered.
